(19) United States
(12) Patent Application Publication
(10) Pub. No.: US 2016/0060955 A1
(43) Pub. Date: Mar. 3, 2016

(54) RETRACTABLE LIGHT-DIFFUSING MODULE AND LIGHT-DIFFUSING STRUCTURE THEREOF

(71) Applicant: Yin-An Hsieh, TAIPEI CITY (TW)

(72) Inventor: Yin-An Hsieh, TAIPEI CITY (TW)

(21) Appl. No.: 14/834,527

(22) Filed: Aug. 25, 2015

(30) Foreign Application Priority Data
Aug. 27, 2014 (TW) 103215346

(51) Int. Cl. E06B 9/386; G02B 5/02; E06B 9/30; E06B 9/326; E06B 9/262; E06B 9/266

(52) U.S. Cl. CPC E06B 9/386; E06B 9/262; E06B 9/266; E06B 9/30; E06B 9/326; G02B 5/0278; E06B 2009/2627

(57) ABSTRACT

The instant disclosure provides a retractable light-diffusing module installed between indoors and outdoors. The retractable light-diffusing module includes a plurality of light-diffusing structures and a plurality of connecting units. The plurality of light-diffusing structures are spaced from each other sequentially, wherein each of the plurality of light-diffusing structures comprises a light-transmitting box and a light-diffusing filler. The light-transmitting box comprises an accommodating space which is filled with the light-diffusing filler. Each of the connecting units is located between each two of the light-diffusing structures to connect the plurality of light-diffusing structures, thereby forming a flat light-diffusing panel. When the outdoor sunlight passes through the flat light-diffusing panel, the sunlight will be transformed into a uniform flat panel light source irradiating the indoors thoroughly. The retractable light-diffusing module may be installed adjacent to the indoor side of a window.

### BACKGROUND

1. Technical Field

The instant disclosure relates to a light-diffusing structure and a retractable light-diffusing module, in particular, to a plurality of light-diffusing structures assembling a retractable light-diffusing module installed beside a window.

2. Description of Related Art

In general, typical window glazing is only for light transmission, i.e., for the sunlight to transmit from outside through the glasses on a window to the indoors. Thus, glasses on a window bring natural light to the indoors. However, the direction of the light transmitted into the indoors depends on the angle at which the outdoor sunlight passing through the glass on a window. Accordingly, the sunlight transmitted into the indoors often focuses on certain places, produces uneven light and glare, and causes temperature rising in the indoors.

In order to solve the problems relating to glare or temperature rising in the indoors, the common solution is to install window shades, blinds, or curtains. However, the use of window shades, blinds, or curtains reduces the brightness of natural light in the indoors, thereby creating the need of artificial lighting. In addition, window shades, blinds, and curtains have poor thermo insulation property.

There is a newly developed window glass that may transform the outdoors light into diffused light in order to overcome the problems related to thermo insulation or glare. However, such a diffusing window is high-cost, and the entire window has to be replaced for changing from an existing window. Besides, it is impossible to see through the diffusing window to view the outside. Furthermore, since the diffusing glass is fixed, it is difficult to remove the diffusing glass. Accordingly, the user cannot avoid the diffusion function of the glass when the user wants to see through the window.

Therefore, there is a need for a retractable light-diffusing device which enables the user to determine the use of the function of light-diffusing, light-balancing, and thermo insulation to overcome the above disadvantages.

### SUMMARY

In view of the problem above, the instant disclosure provides a light-diffusing structure and retractable light-diffusing module with the function of light diffusing, light balancing, and thermo insulation.

In order to achieve the above purpose, an exemplary embodiment of the instant disclosure provides a retractable light-diffusing module installed between outdoors and indoors. The light-diffusing module comprises several light-diffusing structures. Each light-diffusing structure comprises a light-transmitting box and a light-diffusing filler. The light-transmitting box comprises an accommodating space. The light-diffusing filler is placed in the accommodating space. Wherein, the sunlight from the outdoors passes through the light-transmitting box and the light-diffusing filler, and transforms into a uniform flat panel light source irradiating the indoors.

Another exemplary embodiment of the instant disclosure provides a light-diffusing module installed between outdoors and indoors, the light-diffusing module comprises a plurality of light-diffusing structures and a plurality of connecting units. The plurality of light-diffusing structure spaced from each other and sequentially arranged, wherein each of the light-diffusing structure comprises a light-transmitting box and a light-diffusing filler. The light-transmitting box has an accommodating space. The light-diffusing filler is placed in the accommodating space. Each of the connecting units is positioned between each two of the light-diffusing structures in order to connect the plurality of light-diffusing structures, thereby forming a flat light-diffusing panel. The sunlight from the outdoors passes through the flat light-diffusing panel and transforms into a uniform flat panel light source irradiating the indoors. The light-diffusing structure is installed in the indoors adjacent to one side of a window.

The benefits achieved by the instant disclosure resides in that the retractable light-diffusing module provided by the instant disclosure can be installed in front of a window, and may be folded or unfolded by the user. Therefore, the user has the option to use the light-balancing and light-diffusing functions of the light-diffusing structure. Meanwhile, the light-diffusing structure may diffuse the sunlight evenly to irradiate the indoors thoroughly. Accordingly, the light-diffusing structure of the instant disclosure has the function of light-diffusing, light-balancing, eliminating the glare, providing privacy, improving thermo insulation and sound proofing.

In order to further describe the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide further understanding of the present disclosure, and are incorporated in and constitute a part of this specification. The drawings illustrate exemplary embodiments of the present disclosure and, together with the description, serve to explain the principles of the present disclosure.

FIG. 1 is a three-dimensional diagram of the first embodiment of the instant disclosure.

FIG. 2A is a schematic diagram of the second embodiment of the instant disclosure when in use.

FIG. 2B is a schematic diagram of the second embodiment of the instant disclosure at another status of use.

FIG. 2C is a lateral view of the second embodiment of the instant disclosure when in use.

FIG. 2D is a lateral view of the second embodiment of the instant disclosure at another status of use.

FIG. 3A is a three-dimensional schematic diagram of the third embodiment of the instant disclosure when in use.

FIG. 3B is a lateral view of the third embodiment of the instant disclosure when in use.

FIG. 3C is a lateral view of the third embodiment of the instant disclosure at another status of use.

FIG. 4A is a three-dimensional schematic diagram of the fourth embodiment of the instant disclosure when in use.

FIG. 4B is a three-dimensional schematic diagram of a partial enlargement of the fourth embodiment of the instant disclosure.

FIG. 4C is a three-dimensional schematic diagram of the fourth embodiment of the instant disclosure at another status of use.

FIG. 4D is a lateral view of the fourth embodiment of the instant disclosure upon an application when in use.

FIG. 4E is a lateral view of the fourth embodiment of the instant disclosure at another status of use.

FIG. 4F is a side view of the fourth embodiment of the instant disclosure upon yet another status of use.

FIG. 5A is a three-dimensional schematic diagram of the fifth embodiment of the instant disclosure when in use.

FIG. 5B is a lateral view of the fifth embodiment of the instant disclosure when in use.

FIG. 5C is a three-dimensional schematic diagram of the fifth embodiment of the instant disclosure at another status of use.

FIG. 5D is a lateral view of the fifth embodiment of the instant disclosure at another status of use.

FIG. 6 is a three-dimensional schematic diagram of the sixth embodiment of the instant disclosure when in use.

FIG. 7A is a three-dimensional schematic diagram of the seventh embodiment of the instant disclosure when in use.

FIG. 7B is a three-dimensional schematic diagram of the seventh embodiment of the instant disclosure at another status of use.

FIG. 8A is a three-dimensional schematic diagram of the eighth embodiment of the instant disclosure when in use.

FIG. 8B is a three-dimensional schematic diagram of the eighth embodiment of the instant disclosure at another status of use.

### DETAILED DESCRIPTION OF THE INVENTION

Reference will now be made in detail to the exemplary embodiments of the present disclosure, examples of which are illustrated in the accompanying drawings. Wherever possible, the same reference numbers are used in the drawings and the description to refer to the same or like parts.

### First Embodiment

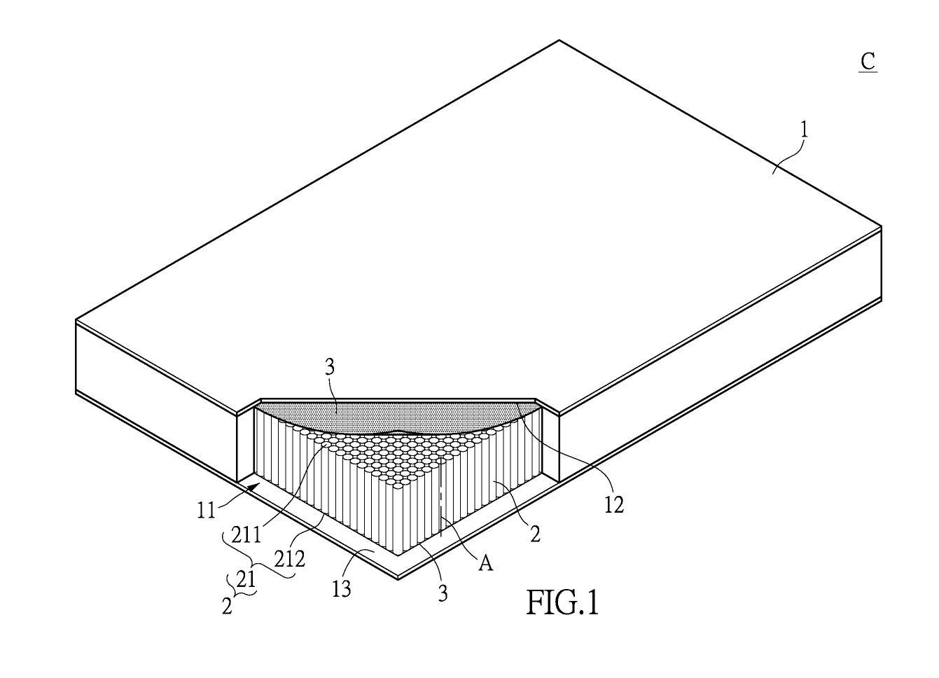

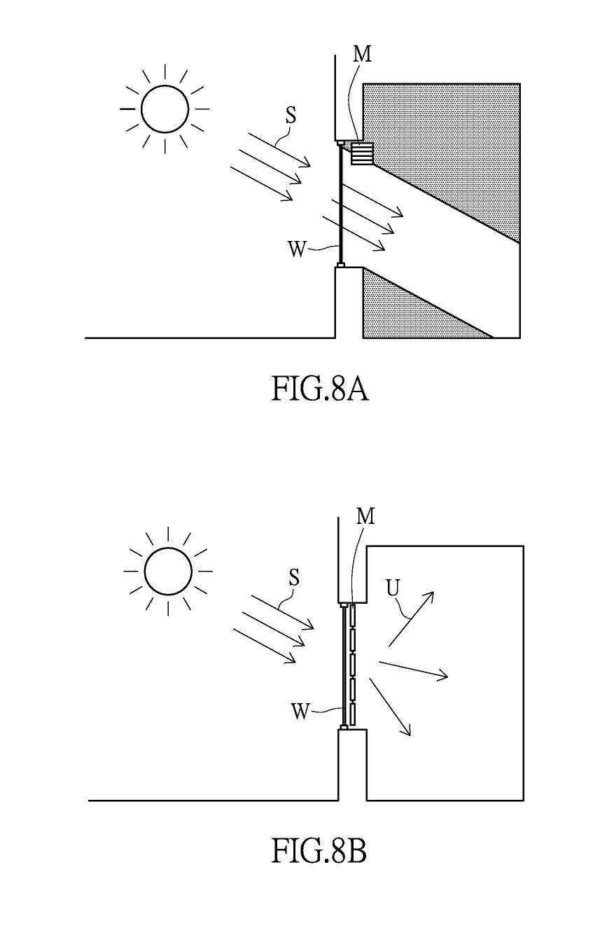

First of all, please refer to FIG. 1, FIG. 8 and FIG. 8B. A first embodiment of the instant disclosure provides a light-diffusing structure C comprising a light-transmitting box 1 and a light-diffusing filler 2. The light-transmitting box 1 has an accommodating space 11, the light-diffusing filler 2 is placed in the accommodating space 11. Therefore, when light passes through the light-transmitting box 1 and the light-diffusing filler 2, it will be transformed into a dispersed and diffused light source. The light-diffusing structure C is installed in the indoors adjacent to one side of a window W. For instance, regarding the first embodiment of the instant disclosure, the light-diffusing filler 2 may be composed of a plurality of hollow thin tubes 21 of acrylic material, or may be composed of a plurality of high transmittance hollow particles of Aerogel. In addition, the light-transmitting box 1 may be a transparent acrylic plate having light-transmitting property.

Specifically, the accommodating space 11 defines a first inner surface 12 and a second inner surface 13 therein, which are located correspondingly with the first inner surface 12 positioned at the opposite side of the second inner surface 13. The light-diffusing material 2 is a plurality of hollow thin tubes 21. Each of the hollow thin tubes 21 has a central axis A, a first end 211, and a second end 212. Both end 211 and end 212 extend along the central axis A toward opposite directions. Each of the central axis A of the plurality of hollow thin tubes 21 is approximately parallel to others in the accommodating space 11. The first end 211 and the second end 212 of the hollow thin tubes abuts the first inner surface 12 and the second inner surface 13, respectively. Accordingly, after the outdoor sunlight passes through the light-transmitting box 1 and the light-diffusing filler 2, it transforms into a uniform flat panel light source irradiating the indoors. It is noted that Aerogel can also be the light-diffusing filler 2 to fill up the entire accommodating space 11 of the light-transmitting box 1.

Furthermore, the light-diffusing structure C provided by the instant disclosure may further comprise a yarn film unit 3 to increase the efficiency of light-uniformity and light-dispersing. The yarn film unit 3 may be placed on the first inner surface 12 and the second inner surface 13, and the light-diffusing filler 2 may be enclosed by the yarn film unit 3 placed on the inner surface 12 and the second inner surface 13. In other words, the first end 211 and the second end 212 of the hollow thin tube 21 abut to the yarn film unit 3 placed on the first inner surface 12 and the second surface 13. Therefore, the outdoor sunlight irradiating into the indoors will pass through the light-transmitting box 1, the yarn film unit 3 and the light-diffusing filler 2 sequentially, and the sunlight is uniformly diffused to the indoors. It is noted that one of the surfaces of the light-transmitting box 1 may be opened (not shown) so that the user may replace the light-diffusing filler 2. In addition, the appropriate distance between the first inner surface 12 to the second inner surface 13 of the light-transmitting box 1 is in the range of 2 to 8 cm. The larger the distance is, the better efficiency of light-diffusing and light-balancing it will be.

The light-diffusing structure C provided in the first embodiment of the instant disclosure may uniformly diffuse the outdoor sunlight to irradiate the indoors thoroughly through the light-diffusing filler 2 and the yarn film unit 3 placed in the light-transmitting box 1. Comparing to the window W without the light-diffusing structure C provided by the instant disclosure, the light-diffusing structure C provided by the instant disclosure may deliver the light to a further distance.

### Second Embodiment

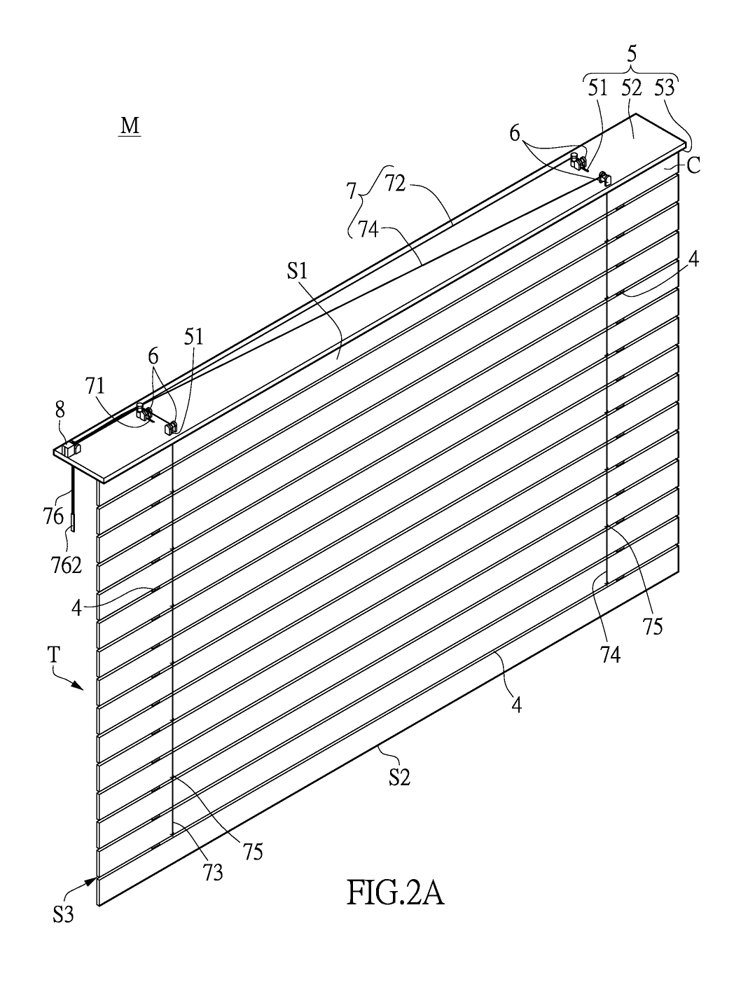

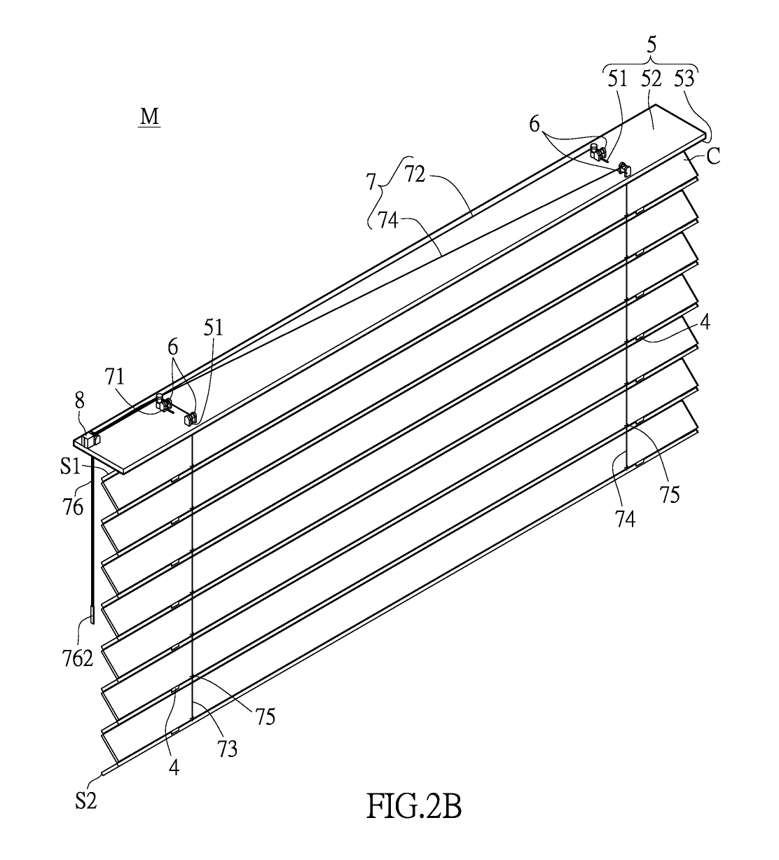

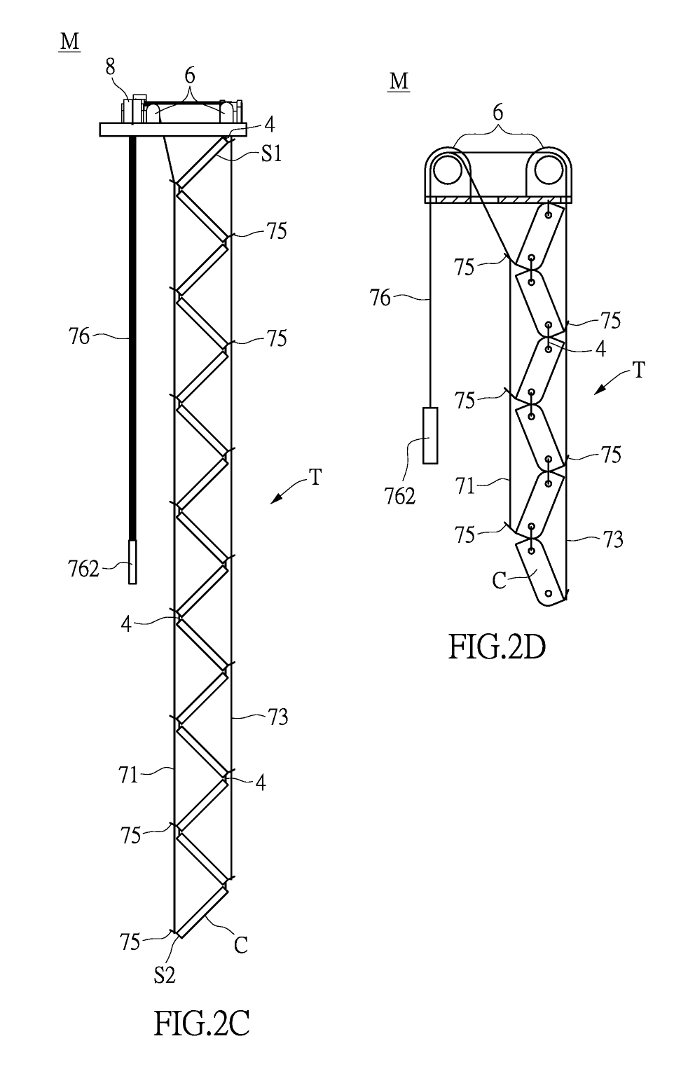

First, please refer to FIG. 2A to 2C. The second embodiment employs the plurality of light-diffusing structures C provided by the first embodiment to form a light-diffusing module M. The light-diffusing module M can also be integrated with the structure of Venetian blinds. As shown from FIG. 2A to 2C, the second embodiment of the instant disclosure provides a light-diffusing module M installed between indoors and outdoors. The light-diffusing module M comprises a plurality of light-diffusing structures C and a plurality of connecting units 4. The plurality of light diffusing structures C are equally spaced with each other, or abut with each other sequentially. Each of the connecting units 4 is placed between each two light-diffusing structures C to connect the plurality of light-diffusing structures C. Accordingly, via the connection provided by the plurality of connection units 4, the plurality of light-diffusing structures C form a panel of light-diffusing panel T. Therefore, the outdoor sunlight pass through the light-diffusing panel T will be transformed into a uniform flat panel light source irradiating the indoors.

Secondly, the light-diffusing structure C in the first embodiment of the instant disclosure can be integrated with the structures of a supporting unit 5, a plurality of direction-changing units 6, and a plurality of cords 7. For example, as shown from FIG. 2A to 2C, there is a connecting unit 4 located between each of the light-diffusing structures C. The connecting unit 4 may be a fabric or a wire. This connecting unit 4 may be either a single connection located at the central gravity axis of each light-diffusing structures C, or a pair of connection at the two opposite sides of the central axis of the light-diffusing structure C. Accordingly, the plurality of light-diffusing structures C form a flat light-diffusing panel T. The flat light-diffusing panel T has a first side S1 and a second side S2 arranged oppositely. The first side 51 connects to a lower surface 53 of a supporting unit 5 through connecters such as connecting units 4 or a hinge. The plurality of direction-changing units are placed at the upper surface 52 of the supporting unit 5. The plurality of cords 7 connect to the plurality of light-diffusing structures C on the flat light-diffusing panel T via a plurality of direction-change units 6. Accordingly, the flat light-diffusing panel T may be folded or unfolded via controlling the plurality of cords 7 and a plurality of direction-changing units 6.

Specifically, the plurality of direction-changing units 6 is located at the four corners of the supporting units 5, and the supporting unit 5 has a plurality of via holes 51 for a first lift cord 71, a second lift cord 72, a third lift cord 73, and a fourth lift cord 74 passing through. The first lift cord 71 and the second lift cord 72 are located at one side of the flat light-diffusing panel T, and the third lift cord 73 and the fourth lift cord 74 are located on the other side of the flat light-diffusing panel T. In addition, the light-diffusing structure C on the flat light-diffusing panel T may also have a plurality of cord-connecting rings 75. As shown in FIG. 2C, a part of the cord-connecting rings 75 are located apart on one side of the flat light-diffusing panel T. The first lift cord 71 and the second lift cord 72 pass through the cord-connecting rings 75 on this side. The other part of the cord-connecting rings 75 are located apart on the other side of the flat light-diffusing panel T. The third lift cord 73 and the fourth lift cord 74 pass through the cord-connecting rings 75 on the other side. One end of the first lift cord 71, the second lift cord 72, the third lift cord 73, and the fourth lift cord 74 connect to the cord-connecting rings 75 located at the lowest light-diffusing structure C. The other end of these cords pass through the plurality of via holes 51 of the supporting unit 5, and gather as a lift cord 76 by passing the plurality of direction-changing units 6 located on the supporting unit 5. Meanwhile, by securing the lift cord 7 through the cord clutch 8 on the supporting unit 5, the user may secure the location of the lift cord 7. However, the instant disclosure is not limited to the above example.

Thirdly, to avoid a gap S3 between each two of the light-diffusing structures C by the presence of the connecting unit 4 between the light-diffusing structures C as shown in FIG. 2A, the connecting unit 4 may be configured as shown in FIG. 2D, i.e., each connecting unit 4 connect every two light-diffusing structures C, and is located at the side of the light-diffusing structures C. At the connecting points, the corners of the light-diffusing structures C are shaped in a circular angle of 45 degrees. Thus, each light diffusing structure C can rotate freely when the lift cord 7 is moving, and there is no gap S3 of the flat light-diffusing panel T. It is noted that the connecting unit 4 may be a flat connector, and is located on the two sides of the central axis of the light-diffusing structure C.

Lastly, please refer to FIGS. 8A and 8B, it is noted that the light-diffusing module M provided by the instant disclosure is located in front of the window W. Without using the light-diffusing structure M, the sunlight S from the outdoors passes through the window W and irradiates only on a certain place of the indoors. By using the light-diffusing structure M, the sunlight S is transformed into a uniform flat panel light source U irradiating the indoors evenly, thereby achieving balanced natural indoor lighting.

### Third Embodiment

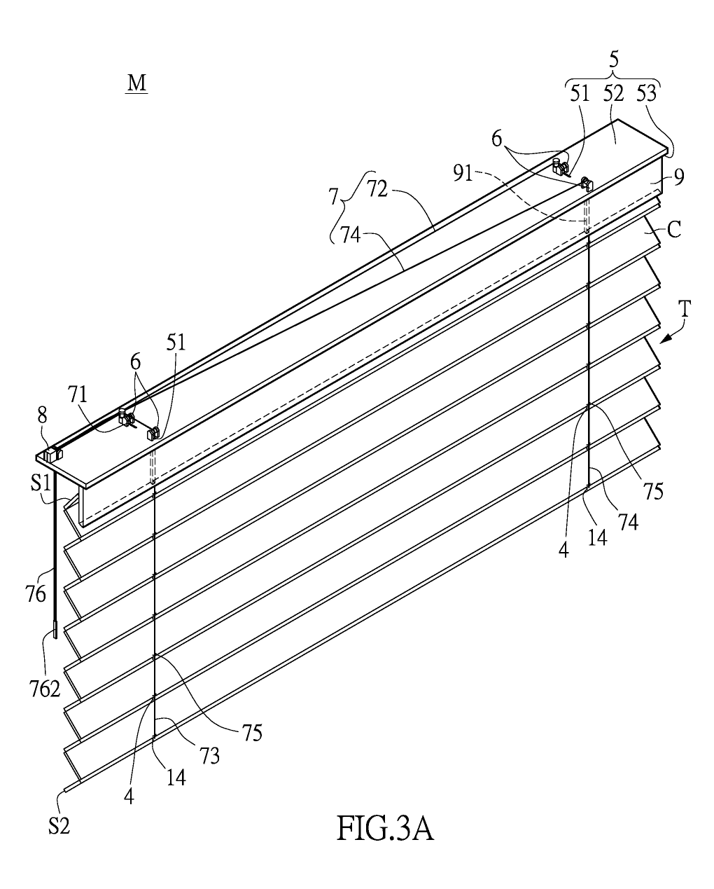

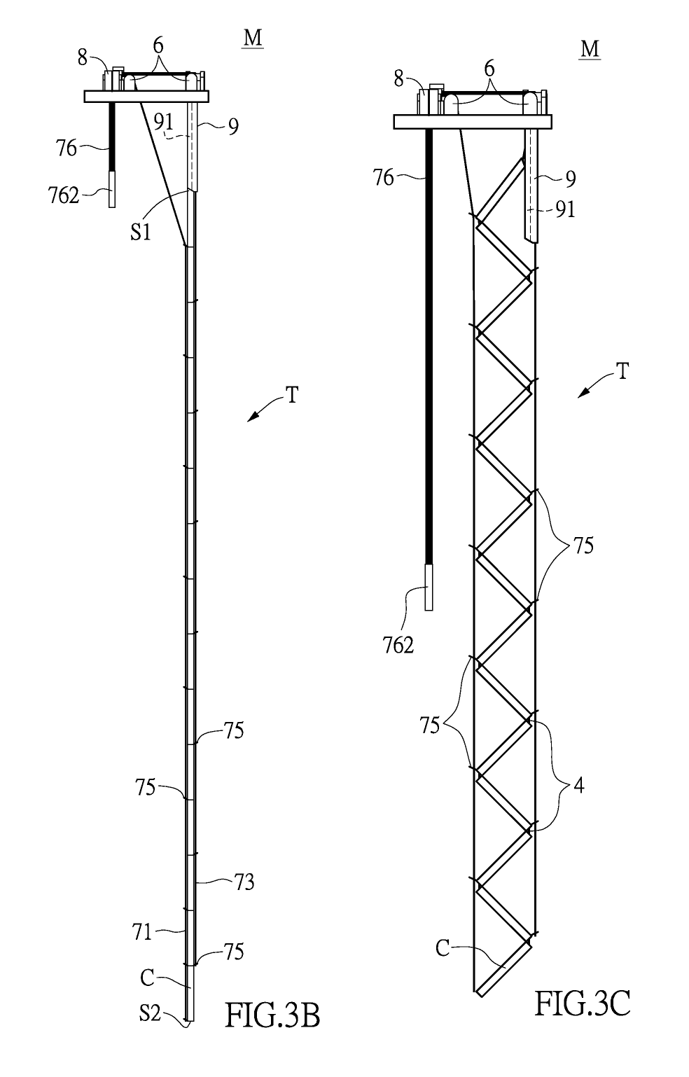

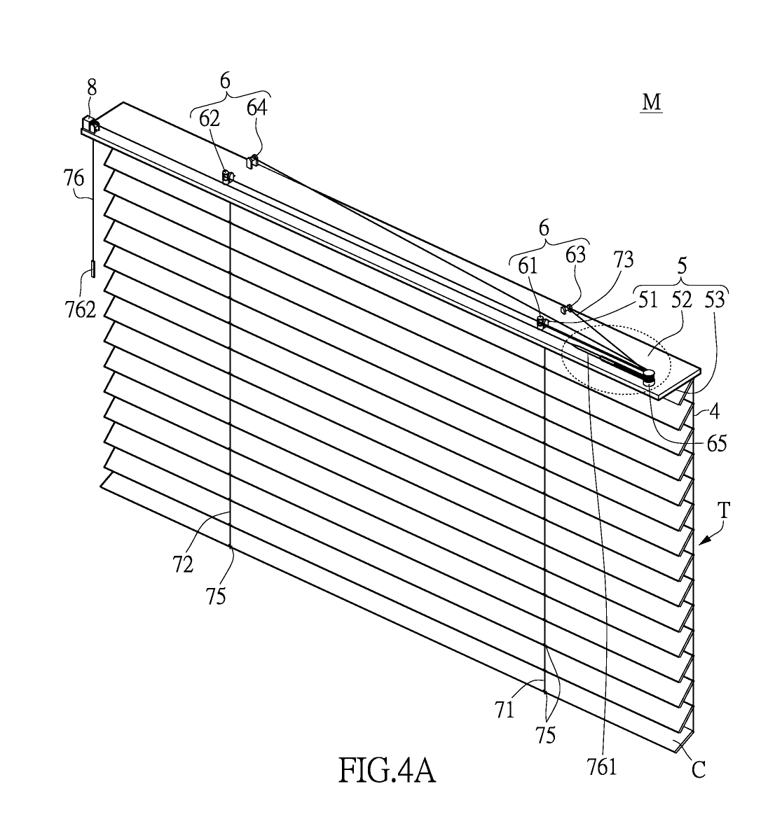

First, please refer to FIGS. 3A to 3C. By comparing FIG. 3C with FIG. 2C, it is noted that the difference between the third embodiment and the second embodiment resides in that the light-diffusing module M provided by the third embodiment comprises an additional shield plate 9, and the location of the connecting unit 4 is changed as well. This difference avoids the gaps between each of the light-diffusing structures C when a user unfolds the light-diffusing module M, thereby improving the uniformity of the light diffusing power of the instant disclosure.

Furthermore, during the manufacturing process, the light-transmitting box 1 of each of the light-diffusing structures C may be formed with a plurality of channels 14 for the connecting units 4 to pass through. The channels 14 directly penetrate the light-transmitting box 1 so that the connecting units 4 may pass through the channels 14 and be located in the center of the light-transmitting box 1. Thus, the plurality of light-diffusing structures C may be arranged sequentially. The shield plate 9 is located at the lower surface 53 of the supporting unit 5 to shield the folded flat light-diffusing panel T. Specifically, when the connecting units 4 are cords, the connecting units 4 may pass through the channels 14 of each of the light-diffusing structures C, rendering the connecting units 4 movable in the channels 14. The end of the connecting units 4 is secured on the light-diffusing structures C on the bottom side S2 of the flat light-diffusing panel T. Accordingly, as shown in FIG. 3B, when the flat light-diffusing panel T is unfolded, the light-diffusing structure C on the first side S1 of the flat light-diffusing panel T and the lower surface of the supporting unit 5 will form a predetermined distance. At the meantime, the material of the shield plate 9 may be the same as the material of the light-diffusing structures C and hence, the shield plate 9 has the light-diffusing power of the light-diffusing structures C. The height of the shield plate 9 may be the same as the predetermined distance to prevent sunlight entering indoors without passing through the light-diffusing structure C. In addition, as shown in FIG. 3A, one side of the shield plate 9 may have grooves 91 to allow the connecting unit 4 extending to the flat light-diffusing panel T through the grooves 91 without deformation.

Lastly, a plurality of direction-changing units 6 are located on the four corners of the supporting unit 5. A plurality of via holes 51 are located on the supporting unit 5 for the first lift cord 71, the second lift cord 72, the third lift cord 73, and the fourth lift cord 74 passing through. When the user pulls the lift cord 76, it may move the first lift cord 71, the second lift cord 72, the third lift cord 73, and the fourth lift cord 74 accordingly. By using the cord-connecting ring 75 located apart at the two opposite sides of the flat light-diffusing panel T, the light-diffusing structures C of the flat light-diffusing panel T may be folded and unfolded sequentially and freely.

### Fourth Embodiment

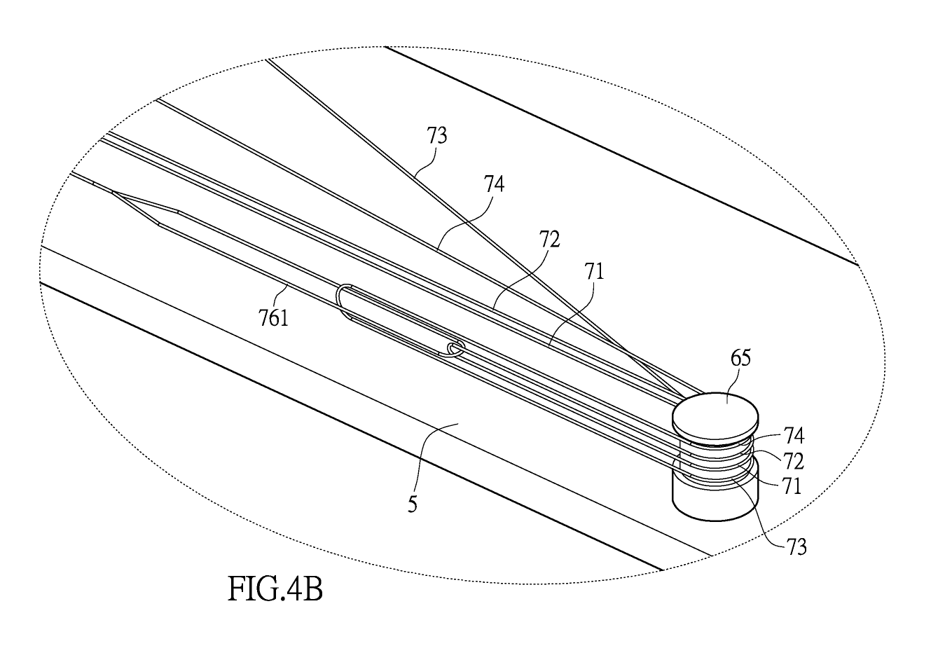

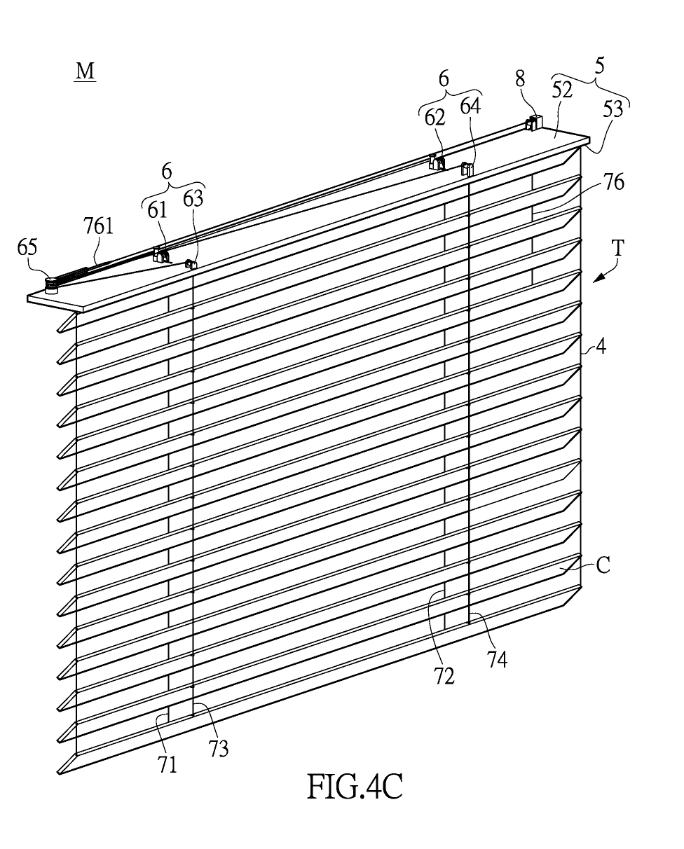

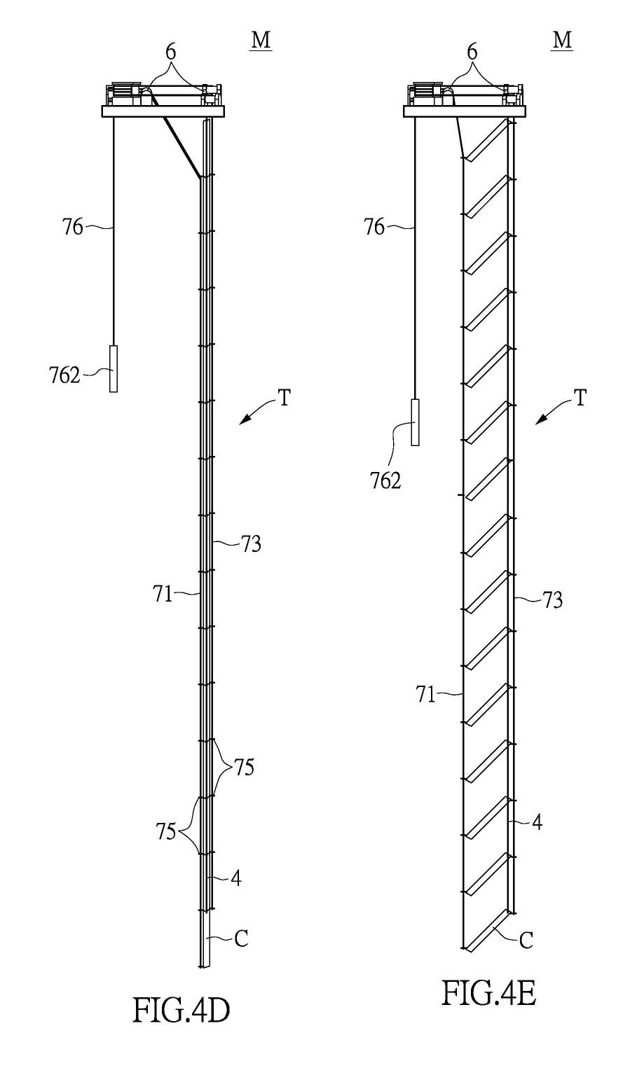

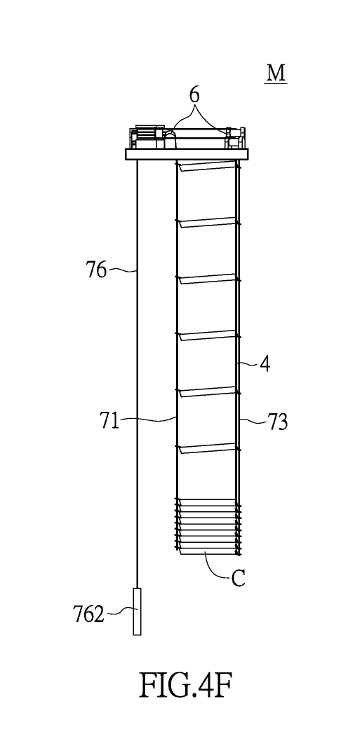

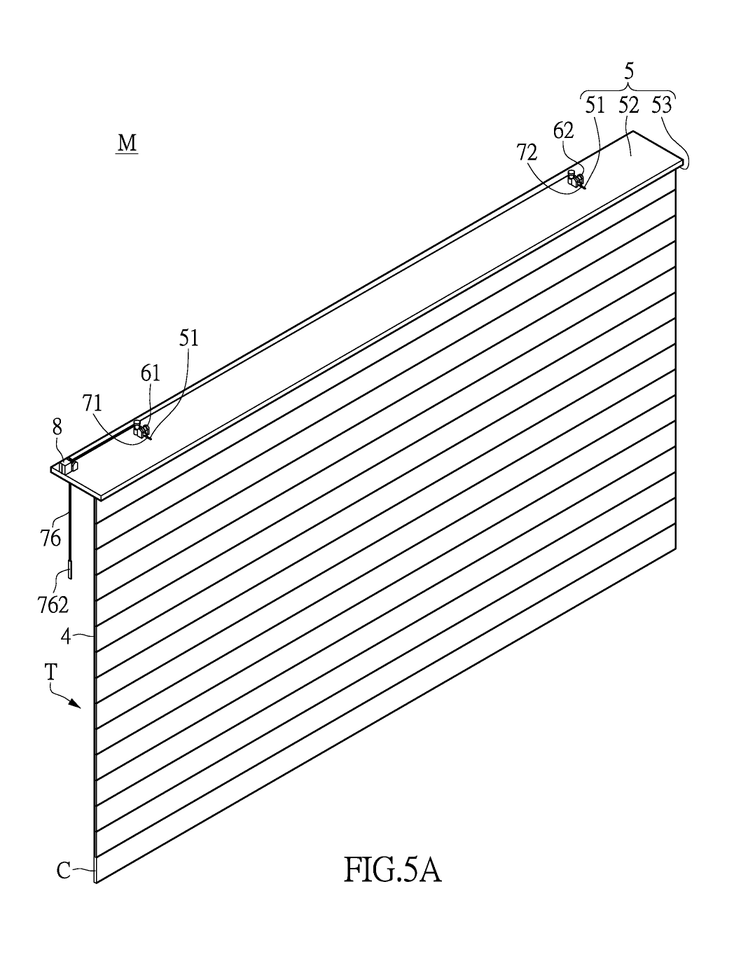

First, please refer to FIGS. 4A to 4E. By comparing FIGS. 4A to 4F and FIG. 2C, it can be seen that the difference between the fourth embodiment and the second embodiment resides in that the arrangement of the light-diffusing module M and the connecting unit 4 is changed. In the fourth embodiment, the connection between the first lift cord 71, the second lift cord 72, the third lift cord 73, and the fourth lift cord 74 and the plurality of connecting units 6 is configured differently to allow each light-diffusing structure C rotating along its corner at the same side.

Specifically, a first direction-changing unit 61, a second direction-changing unit 62, a third direction-changing unit 63, a fourth direction-changing unit 64, and a fifth direction-changing unit 65 are located on the top surface of the supporting unit 5. A plurality of via holes 51 are located on the supporting unit 5 for the first lift cord 71, the second lift cord 72, the third lift cord 73, and the fourth lift cord 74 to pass through. The first lift cord 71 and the second lift cord 72 are located on one side of the flat light-diffusing panel T, and the third lift cord 73 and the fourth lift cord 74 are located on the other side of the flat light-diffusing panel T. A part of the cord-connecting rings 75 may be located apart on one side of the flat light-diffusing panel T for the first lift cord 71 and the second lift cord 72 to pass through. The other part of the cord-connecting rings 75 are located apart on the other side of the flat light-diffusing panel T for the third lift cord 73 and the fourth lift cord 74 to pass through. Each end of the first lift cord 71, the second lift cord 72, the third lift cord 73, and the fourth lift cord 74 is connected to the last cord-connecting rings 75 located at the lowest light-diffusing structure C. The other ends of these lift cords 7 pass through the plurality of via holes 51 located on the supporting unit 5. The plurality of connecting units 4 are located at the two sides of each light-diffusing structures C to connect each two light-diffusing structures C respectively.

As shown in FIG. 4A to 4C, regarding to the first lift cord 71 and the second lift cord 72, the first direction-changing unit 61 is over the first lift cord 71, and the second direction-changing unit 62 is over the second lift cord 72. The other ends of the first lift cord 71 and the second lift cord 72 pass through the first direction-changing unit 61 and the second direction-changing 62 respectively, and move toward the fifth direction-changing unit 65. The end of the first lift cord 71 and the end of the second lift cord 72 connect with each other. Furthermore, the third direction-changing unit 63 is over the third lift cord 73, the fourth direction-changing unit 64 is over the fourth lift cord 74. The other side of the third lift cord 73 and the fourth lift cord 74 pass through the third direction-changing unit 63, the fourth direction-changing unit 64, and extend toward the fifth direction-changing unit 65. The ends of the third lift cord 73 and the fourth lift cord 74 connect to each other. Next, one end of the lift cord 76 with a tassel 762 may be pulled by a user to fold or unfold the light-diffusing module M. The other end of the lift cord 76 has a ring portion 761. The ring portion 761 surrounds the connection of the first lift cord 71 and the second lift cord 72, and the connection of the third lift cord 73 and the fourth lift cord 74. Specifically, as shown by FIG. 4D to 4F, when the user grabs the end of the lift cord 76 with the tassel 762, the ring portion 761 of the lift cord would lead the first lift cord 71 and the second lift cord 72 to move accordingly, so that the first lift cord 71 and the second lift cord 72 would move for a predetermined distance. Therefore, the first lift cord 71 and the second lift cord 72 may lead each of the light-diffusing structures C to rotate. When the light-diffusing structures C rotate to the horizontal position, the ring portion 761 of the lift cord 76 would pull the connection of the first lift cord 71 and the second lift cord 72 to meet the connection of the third lift cord 73 and the fourth lift cord 74. Continuing the pulling of the lift cord 76 at the tassel 762 side, the ring porting 761 starts to pull the first lift cord 71, the second lift cord 72, the third lift cord 73, and the fourth lift cord 74 together to retract each light-diffusing structures C respectively. Meanwhile, the plurality of connecting units 4 located on the side of the light-diffusing structure T may be folded and held between each two light-diffusing structures C, or may be folded outside of the light-diffusing structures C.

Accordingly, when there is a need to rotate the light-diffusing module M to generate an angle, the user may pull the lift cord 76, thereby leading the first lift cord 71 and the second lift cord 72 to rotate the light-diffusing structure C for an angle, and the rotation of the light-diffusing structure C may be fixed by the cord clutch 8.

### Fifth Embodiment

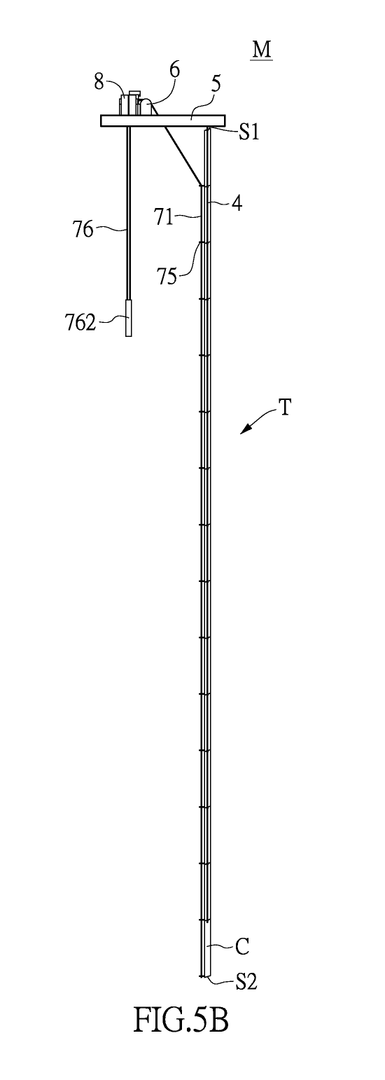

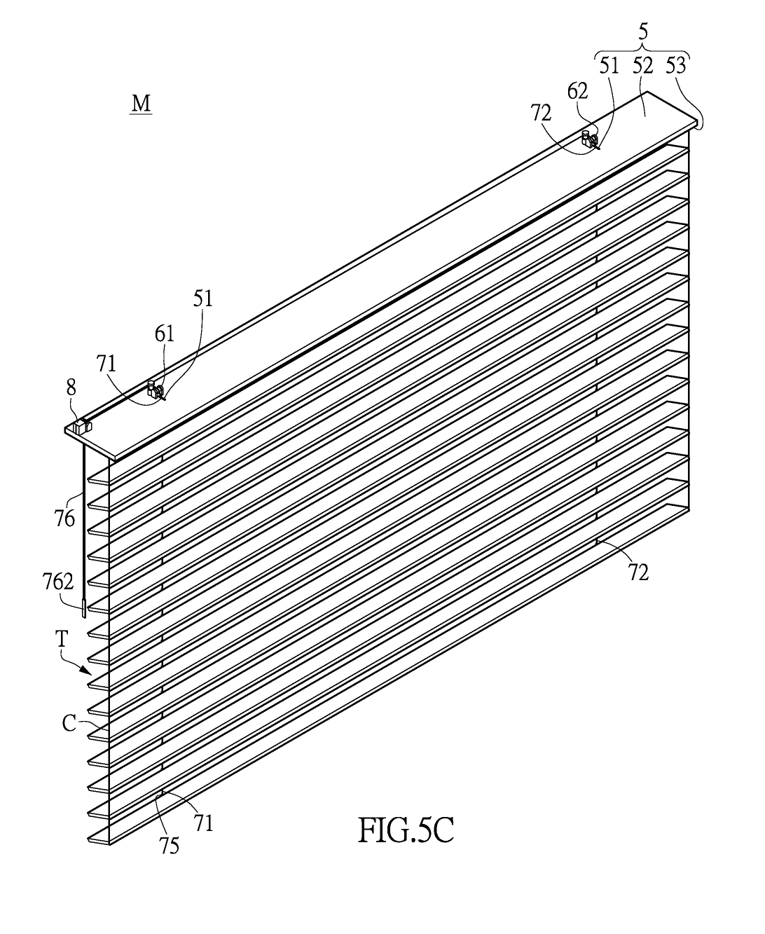

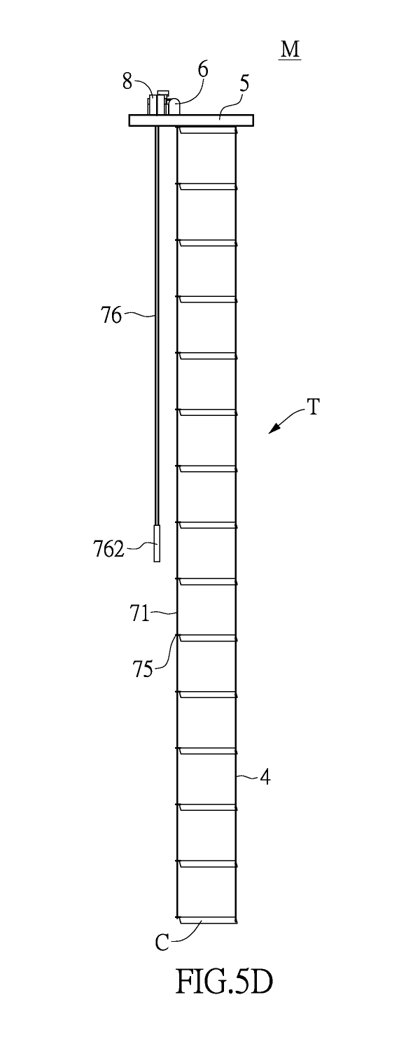

Please refer to FIGS. 5A to 5D. By changing the arrangement of the connecting units 4 and the lift cord 7, the light-diffusing module M may be fixed. Accordingly, by using the lift cord 76, the light-diffusing structure C generates a rotating angle, and the lift cord 76 is held by the cord clutch 8 to fix the rotation angle of the light-diffusing structure M.

### Sixth Embodiment

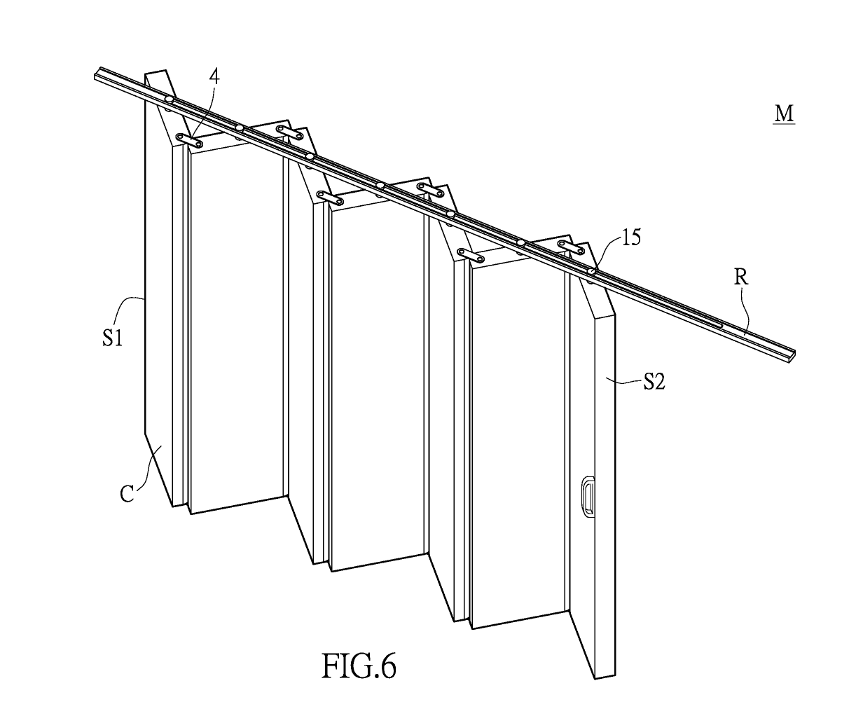

First, please refer to FIG. 6. By comparing FIG. 6 and FIGS. 2A to 2D, it is noted that the difference of the sixth embodiment and the second embodiment resides in that the second embodiment provides a horizontal light-diffusing structure M, and the sixth embodiment provides a vertical light-diffusing structure M. As shown in FIG. 6, the light-diffusing structure M comprises a plurality of light-diffusing structures C, a plurality of connecting units 4, and a rail unit R. The plurality of light-diffusing structures C may be sequentially arranged by fixed space between each other, or sequentially arranged by abutting with each other. Each of the connecting units 4 are located between each two of the light-diffusing structures C to connect a plurality of light-diffusing structures C. Therefore, a plurality of light-diffusing structures C may form a flat light-diffusing panel T by the connection of a plurality of connecting units 4. The sunlight from the outdoors pass through the light-diffusing panel T and transform into a panel light source irradiating the indoors.

Specifically, the side of the light-transmitting box 1 on each of the light-diffusing structures C may have a slide unit 15 located thereon. The slide unit 15 may move freely along the rail unit R. A plurality of connecting units 4 located at the both sides of the light-diffusing structure C connect each two the light-diffusing structures C respectively. The connecting unit 4 may be in the shape of a plate or a rod to secure the distance between each two of the light-diffusing structures, and serve as the rotating axis of the light-diffusing structure C. In addition, the corners of the light-diffusing structure C may have a circular angle (as shown in FIG. 2D) for folding the light-diffusing module M without a gap. Accordingly, when the first side Si of the light-diffusing structure T is fixed on the supporting unit 5 (not shown), the user may unfold the light-diffusing module M by pulling the second side S2 of the light-diffusing panel T. It is noted that the light-diffusing module M may be installed on one of the skylights on the roof.

### Seventh Embodiment

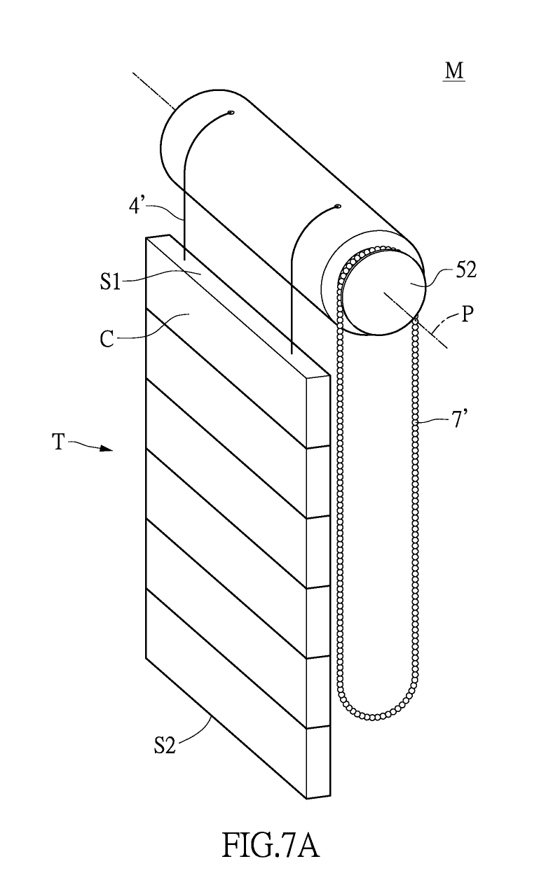

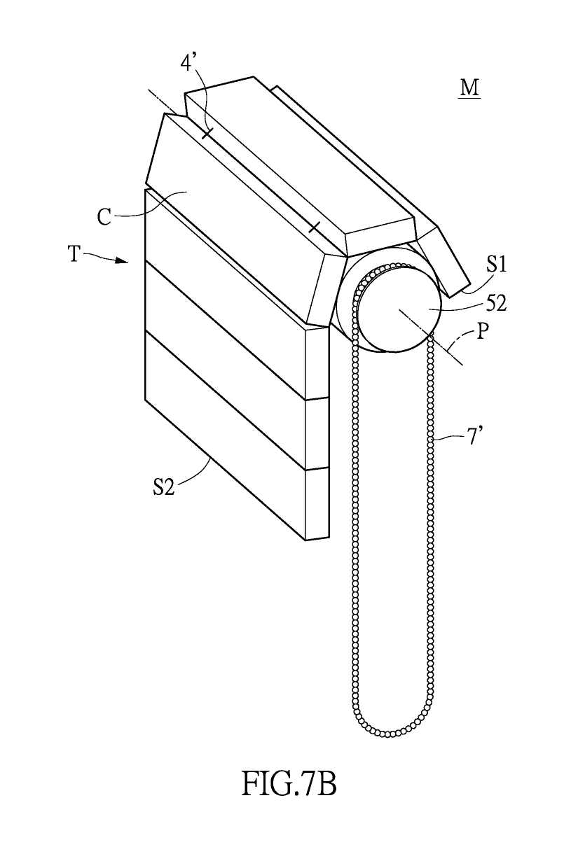

First, please refer to FIGS. 7A and 7B. By comparing FIGS. 7A to 7B and FIGS. 2A to 2D, it is noted that the difference between the seventh embodiment and the second embodiment resides in that the seventh embodiment is integrated with the structure of a roller shade.

The supporting unit 5′ provided by the seventh embodiment may be a cylinder or an extruded polygon. The supporting unit 5′ has an axis P, and the supporting unit 5′ may be rotated along the axis P. The connecting unit 4′ of the seventh embodiment may be a cord penetrating the center of each light-diffusing structures C. The first side Si of the light-diffusing panel T is connected to the supporting unit 5′ through a connecting unit 4′, and the other end of the connecting unit 4′ is secured at the last light-diffusing structure C. In addition, a bead chain 7′ may be provided to rotate the supporting unit 5′. Accordingly, the flat light-diffusing panel T would be rolled up with the supporting unit 5′, thereby retracting the flat light-diffusing panel T.

### [Effectiveness Achieved by the Embodiment]

As discussed above, the benefits provided by the instant disclosure resides in that the retractable light-diffusing module M may diffuse the outdoor sunlight evenly throughout the indoors by the light-diffusing filler 2 and yarn film 3 placed in the light-transmitting box 1. Meanwhile, by utilizing the supporting unit 5, a plurality of direction-changing units 6, a plurality of cords 7, and plurality of connecting units 4, the flat light-diffusing panel T may be retractable. In addition, the lift cord 7 may be further used with devices such as motors, rollers or hinges, to enable controlling the folding and unfolding motion of the light-diffusing structure M through electrical operation. It is worthwhile to mention that the light-diffusing module M provided by the instant disclosure is located in the indoors as Venetian blinds or roller shades (i.e., box-like Venetian blinds or roller shades with light-diffusing filler placed therein). Since it is composed of a plurality of light-diffusing structures C, it may be retractable.

The above-mentioned descriptions represent merely exemplary embodiments of the present disclosure, without any intention to limit the scope of the present disclosure thereto. Various equivalent changes, alterations or modifications based on the claims of present disclosure are all consequently viewed as being embraced by the scope of the present disclosure.

What is claimed is:

1. A light-diffusing structure installed between indoors and outdoors, comprising:
a light-transmitting box with an accommodating space; and
a light-diffusing filler placed in the accommodating space;
wherein outdoor sunlight passes through the light-transmitting box and the light-diffusing filler, and transforms into a uniform flat panel light source irradiating the indoors thoroughly;
wherein the light-diffusing structure is located in the indoors and adjacent to one side of a window.

2. The light-diffusing structure according to claim 1, wherein the accommodating space defines a first inner surface and a second inner surface, the light-diffusing filler comprises a plurality of hollow thin tubes, each of the hollow thin tubes has a central axis and has a first end and a second end extending along the central axis toward opposite direction, wherein the center axis for each of the hollow thin tubes are approximately parallel to each other, and the plurality of hollow thin tubes are placed in the accommodating space, the first end and the second end of the hollow thin tubes abut the first inner surface and the second inner surface respectively.

3. The light-diffusing structure according to claim 2, further comprising:
a yarn film unit arranged on the first inner surface and the second inner surface, wherein the first end and the second end of the hollow thin tubes abut the yarn film unit on the first inner surface and the second inner surface respectively.

4. The light-diffusing structure according to claim 2, wherein the distance between the first inner surface and the second inner surface is in the range of 2 to 8 centimeters.

5. The light-diffusing structure according to claim 2, wherein the hollow thin tubes is made from transparent acrylic material.

6. The light-diffusing structure according to claim 1, wherein the light-diffusing filler is Aerogel.

7. A retractable light-diffusing module installed between indoors and outdoors, comprising:
a plurality of light-diffusing structures spaced with each other and arranged sequentially, wherein each of the light-diffusing structures comprises:
a light-transmitting box having an accommodating space; and
a light-diffusing filler positioned within the accommodating space; and
a connecting unit, the connecting unit is arranged between each two of the light-diffusing structures to connect the plurality of light-diffusing structures and forming a flat light-diffusing panel;
wherein outdoor sunlight passes through the light-transmitting box and the light-diffusing filler and transforms into a uniform flat panel light source irradiating the indoors thoroughly.

8. The retractable light-diffusing module of claim 7, wherein the accommodating space defines a first inner surface and a second inner surface, the light-diffusing filler comprises a plurality of hollow thin tubes, each of the hollow thin tubes has a central axis and has a first end and a second end extending along the central axis toward opposite directions, wherein the central axis of each hollow thin tubes are approximately parallel to each other, and the plurality of hollow thin tubes are placed in the accommodating space, the first end and the second end of the hollow thin tubes abut the first inner surface and the second inner surface respectively.

9. The retractable light-diffusing module of claim 8, further comprising:
a yarn film unit arranged on the first inner surface and the second inner surface, wherein the first end and the second end of the hollow thin tubes abut the yarn film unit on the first inner surface and the second inner surface respectively.

10. The retractable light-diffusing module of claim 8, wherein the distance between the first inner surface and the second inner surface is in the range of 2 to 8 centimeters.

11. The retractable light-diffusing module of claim 7, wherein the connecting unit is a fabric or a wire.

12. The retractable light-diffusing module of claim 7, wherein the light-diffusing filler is Aerogel.

13. The retractable light-diffusing module of claim 7 further comprising: a supporting unit, a plurality of direction-changing units and a plurality of cords, the plurality of direction-changing units are located on the supporting unit, one side of the flat light-diffusing panel connects to the supporting unit, wherein one end of each of the plurality of the cords passes through the plurality of direction-changing units respectively and connects to the plurality of light-diffusing structures of the light-diffusing panel, and the light-diffusing structures are rotated to a certain angle when the other end of each cords is pulled.

14. The retractable light-diffusing module of claim 7, further comprising: a supporting unit, a plurality of direction-changing units and a plurality of cords, the plurality of direction-changing units are located on the supporting unit, one side of the light-diffusing panel connects to the supporting units, wherein one end of each of the plurality of the cords passes through the plurality of direction-changing units respectively and connects to the plurality of light-diffusing structures of the light-diffusing panel, and the light-diffusing panel may be retractable by pulling the other end of each of the cords.

15. The retractable light-diffusing module of claim 14, further comprising: a plurality of cord-connecting rings, wherein one part of the plurality of cord-connecting rings are located apart on one side of the flat light-diffusing panel, the other part of the plurality of cord-connecting rings are located apart at the other side of the flat light-diffusing pane, the supporting unit has a plurality of via holes located thereon, the plurality of cords pass through the plurality of cord-connecting rings, the plurality of via holes, and the plurality of direction-changing units, thereby gathering as a lift cord.

16. The retractable light-diffusing module of claim 15, wherein the direction-changing units comprise a first direction-changing unit, a second direction-changing unit, a third direction-changing unit, and a fourth direction-changing unit; the cords comprises a first cord, a second cord, a third cord, and a fourth cord.

17. The light-diffusing module of claim 7, further comprising: a supporting unit, a plurality of direction-changing units, a plurality of cords and a plurality of cord-connecting rings; the plurality of direction-changing units are located on the supporting unit, one side of the flat light-diffusing panel is connected to the supporting unit wherein the direction-changing unit comprises a first direction-changing unit, a second direction-changing unit, a third direction-changing unit, a fourth direction-changing unit and a fifth direction-changing unit; the cords comprise a first cord, a second cord, a third cord, a fourth cord, and a lift cord; wherein a part of the plurality of cord-connecting rings are located apart at one side of the flat light-diffusing panel, while the other part of the plurality of cord-connecting rings are located apart at the other side of the flat light-diffusing panel; the supporting unit has a plurality of via holes located thereon, one end of each of the first cord, the second cord, the third cord, and the fourth cord pass through the plurality of cord-connecting rings respectively and pass through the plurality of via holes and connect to the plurality of light-diffusing structures of the flat light-diffusing panel; the other end of the first cord and the second cord pass through the first direction-changing unit and the second direction-changing unit respectively, extend toward the fifth direction-changing unit, and connect to each other at their end points, the other ends of the third cord and the fourth cord pass through the third direction-changing unit and the fourth direction-changing unit respectively, move toward the fifth direction-changing unit, and connect to each other at their end points, one of the ends of the lift cord has a circular portion, the circular portion surrounds the connection point of the first cord and the second cord, and the other connection point of the third cord and the fourth cord, respectively.

18. The light-diffusing module of claim 7, further comprising: a rail unit, wherein one side of each of the light-transmitting boxes has a slide unit, the slide unit may move freely along on the rail unit.

19. The light-diffusing module of claim 14, further comprising: a shield plate, the shield plate is located at one side of the supporting unit to shield the retracted light-diffusing panel.

20. The light-diffusing module of claim 7, further comprising:
a cylinder or an extruded polygon supporting unit, a plurality of connecting cords, and a bead chain, wherein one end of each connecting cord is connected to the supporting unit, the other end of each connecting cord penetrate the center of each lighting-diffusing structure, and connect to center of a last light diffusing structure, the supporting unit has a central axis, and the bead chain is pulled and the supporting unit rotates along the central axis, the light-diffusing structures may be retracted or released, thereby retracting or expending the light-diffusing panel.
